(19) United States
(12) Patent Application Publication
(10) Pub. No.: US 2008/0086545 A1
(43) Pub. Date: Apr. 10, 2008

(54) NETWORK CONFIGURATION USING CONFIGURATION PARAMETER INHERITANCE

(75) Inventors: GARY P. FATT, ROLLING MEADOWS, IL (US); JOHN D. HARPER, PRINCEVILLE, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., SCHAUMBURG, IL (US)

(21) Appl. No.: 11/464,923

(22) Filed: Aug. 16, 2006

(51) Int. Cl. G06F 15/177

(52) U.S. Cl. 709/220

(57) ABSTRACT

In a network, a hierarchy of network element classes is identified in which members of a network element class share common configuration parameters. A sub-class of a network element class inherits configuration parameters from the parent network element class. At least part of the hierarchy of network element classes is presented on a computer display to facilitate navigation and management of configuration parameters. Management of configuration parameters may include editing configuration parameters of existing network elements, generating reports of configuration parameters and configuring new network elements.

### BACKGROUND

In a trunked radio network, users share a limited number of communication channels. These channels are used for communication of audio, data, control signals and network management signals. In a trunked radio network, the access points of the network are referred to as sites. The access points allocate communication channels to individual users of the network. The network is managed and controlled by one or more centralized resources, called master sites. An important part of network management is configuration management. A user configuration manager (UCM) is a software tool that enables a network operator to configure the network. A UCM may be used to create, modify, and verify the syntax of configuration files. The configuration data is stored on a user configuration server (UCS). A network may include a number of interconnected zones, or sub-networks, each with its own master site. The user configuration data may be replicated on a zone database server (ZDS) in each zone to ensure that all zones of the network share the same configuration information.

Configuration parameters are often common across multiple device types in a trunked radio network. For example, a site identifier (site ID) is a shared parameter across all site types in the system. Consequently, an existing UCM application may include the ability to copy or clone an existing site to provide an initial configuration file or framework for a new site or device.

Existing UCM applications have several limitations. Firstly, cloning is only performed when a configuration is first performed. If, subsequently, a common parameter is changed, a network operator must navigate each site type individually to update the parameter. Secondly, it is not easy for a network operator to generate reports of all configurations. For example, to generate a report of all the site ID's currently in use, the operator must navigate to each of the site types and generate a report for each site type in turn.

### BRIEF DESCRIPTION OF THE DRAWINGS

The novel features believed characteristic of the invention are set forth in the appended claims. The invention itself will best be understood by reference to the following detailed description of illustrative embodiments when read in conjunction with the accompanying drawing(s), wherein:

FIG. 1 is a diagram of an exemplary trunked radio network.

FIG. 2 is an exemplary diagram of a table of configuration parameters.

FIG. 3 is an exemplary diagram of a table of configuration parameters segmented in accordance with certain embodiments of the invention.

FIG. 4 is a diagram of an exemplary hierarchical class structure consistent with certain embodiments of the invention.

FIG. 5 is a diagrammatic representation of a computer display generated by a UMC application, consistent with certain embodiments of the invention.

FIG. 6 is a further diagrammatic representation of a computer display generated by a UMC application, consistent with certain embodiments of the invention.

FIG. 7 is a flow chart of a method for displaying configuration parameters of network elements of a radio network consistent with certain embodiments of the invention.

FIG. 8 is a flow chart of a method for configuring a new network element consistent with certain embodiments of the invention.

### DETAILED DESCRIPTION

While this invention is susceptible of embodiment in many different forms, there is shown in the drawings and will herein be described in detail one or more specific embodiments, with the understanding that the present disclosure is to be considered as exemplary of the principles of the invention and not intended to limit the invention to the specific embodiments shown and described. In the description below, like reference numerals are used to describe the same, similar or corresponding parts in the several views of the drawings.

In a trunked radio network, users share a limited number of communication channels. Trunking is the commonly accepted term for electronically controlled sharing of a relatively small number of communications channels among a relatively large number of users. In general terms, a trunk is a shared voice or data traffic path between two points. Trunked systems use access control schemes to share channel capacity among many users. The electronic control enables users to take advantage of the fact that some transmitted channels are idle at a particular time while others are busy. This results in a more balanced load sharing between trunks. This is in contrast to a non-trunked or conventional system, where the users exercise their own coordination regarding access to system resources, by listening for idle time and making manual channel selections, which may result in unbalanced channel loads.

Trunked architectures differ by implementation of the system's control logic. There are two main types of trunking architectures: dedicated control channel (also known as centralized trunking) and sub-audible signaling control (also known as decentralized trunking). A combination of the two is also used in some systems.

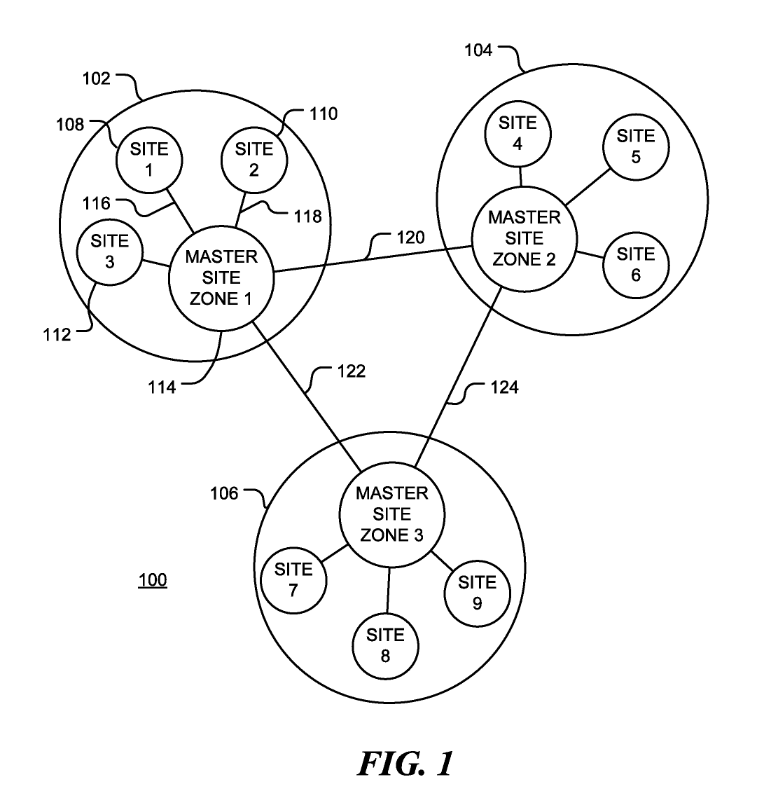

FIG. 1 is a diagram of an exemplary trunked radio network. The network 100 includes three zones, 102, 104 and 106. Each zone includes a number of sites, one of which is a master site. A controller at each site controls access by users to the limited number of RF communication channels. A master site is a central point of control for a group of sites. It performs control, call processing and network management functions. A zone controller at the master site coordinates call processing, assignment of system-wide resources and distribution of audio to all other sites in the system. For example, zone 1 (102) includes sites 108, 110 and 112 and a master site 114. The sites enable individual users, such as console users, portable radio users and mobile radio users, to access the network. Each site in a zone is connected to the master site which includes the zone controller. For example, communication channel 116 connects site 108 to the master site 114, and communication channel 118 connects site 110 to the master site 114. The communication channels enable transport of audio, data, control and network management signals. The zones are also connected by communication links. For example, zone 102 is coupled via link 120 to zone 104, zone 102 is coupled via link 122 to zone 106, and zone 104 is coupled via link 124 to zone 106. These links are controlled by the master sites in each zone.

Configuration management is an important part of network management. A UCM or a ZCM application is a software tool that enables a network operator to configure a network. A UCM (or ZCM) application may be used to create, modify, and verify the syntax of configuration files. The user configuration data is stored on a UCS at the master site. As discussed above, a network may include a number of interconnected zones, or sub-networks, each with its own master site. The user configuration data may be replicated on a ZDS in each zone to ensure that all zones of the network share the same configuration information.

Configuration parameters may include the name, description, network address, broadcast address, operation definitions and basic networking characteristics (such as bandwidth) of the site. The configuration parameters describe the resources and properties of a system level component, such as a site, or a user device (such as a console, a portable radio or a mobile radio, for example).

The configuration data may be, for example, stored in configuration files. In one embodiment, these files may be written in ASCII text and line-oriented, with lines terminated by a new-line or carriage-return/line-feed pair, depending on the operating system. In a further embodiment, the configuration data may be stored in a database. In a still further embodiment the configuration data is stored in configuration files using the extensible markup language (XML) format or the YAML data serialization format. These formats have the advantages of having well-defined syntaxes, and there exist tools to validate and verify the syntax of the files that are created in those formats. Other data storage formats will be apparent to those of ordinary skill in the art.

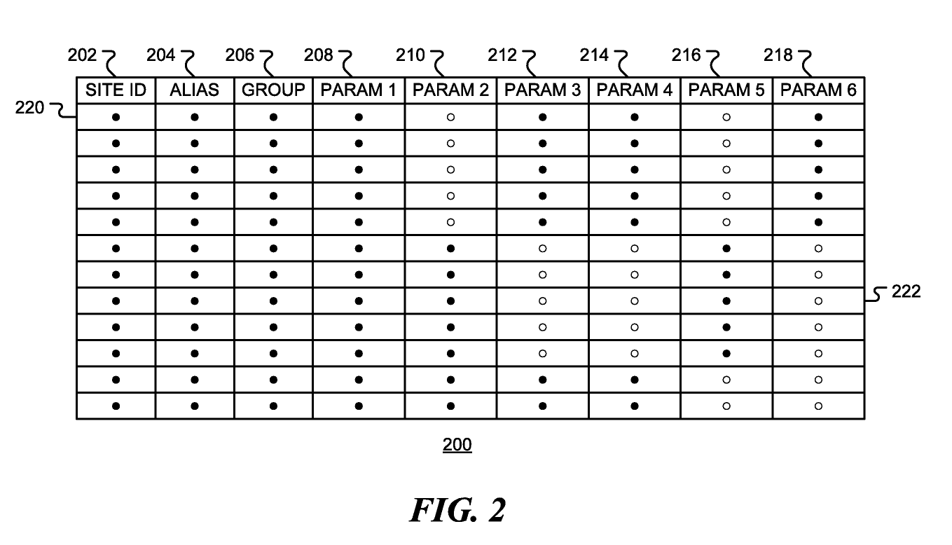

FIG. 2 is an exemplary diagram of a table of configuration parameters. The table 200 contains the configuration parameters for a number of network elements. In this example, the parameters include a site identifier (SITE ID), a site alias (ALIAS), a security group (GROUP), indicated by column fields 202, 204 and 206, respectively in FIG. 2, and a number of parameters indicated by fields 208, 210, 212, 214, 216 and 218. Each row of the table contains the parameter values for a particular network element. A table entry containing a filled circle, such as table entry 220, denotes that the network element of that row requires the value of parameter of that column to be specified. For example, table entry 220 contains a filled circle so the first network element requires a SITE ID value. Conversely, a table entry containing an unfilled circle, such as table entry 222, denotes that the network element of that row does not require the parameter of that column. For example, table entry 222 contains an unfilled circle so the eighth network element does not require parameter 6 (218) to be set.

Examination of the table 200 in FIG. 2 shows that the first four parameters (SITE ID, ALIAS, GROUP and PARAM 1) are required by all of the network elements. In this sense, all of the elements of the same type or class. However, within that class, the network elements require parameters in different combinations.

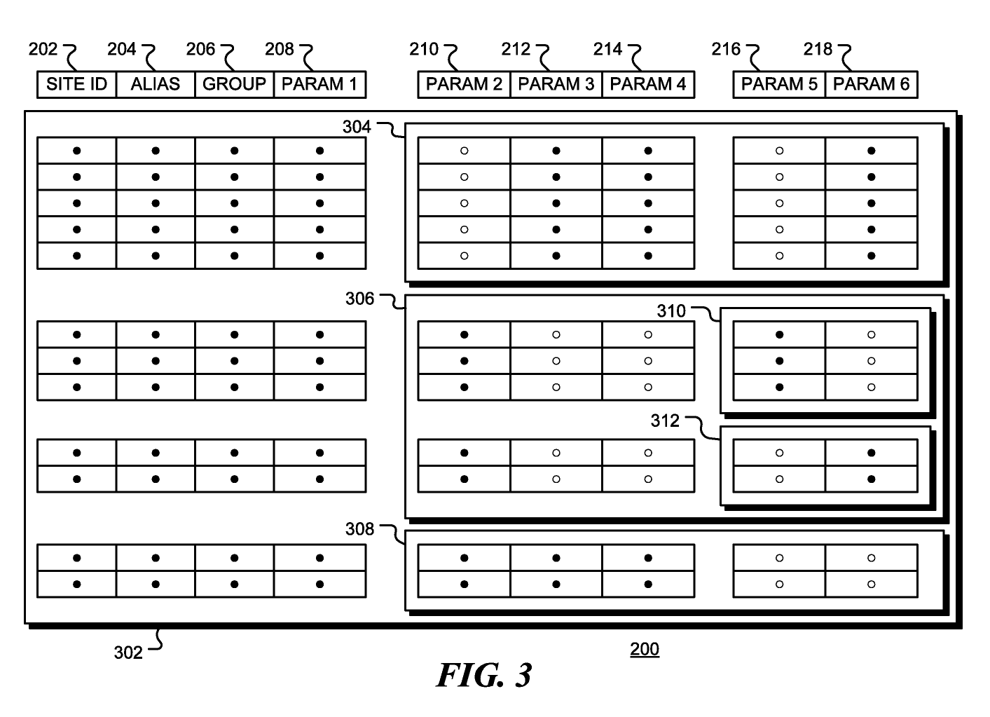

FIG. 3 is a further diagram of the table 200 of FIG. 2. Referring to FIG. 3, the network elements have been segmented into a number of classes and sub-classes of network elements. The class denoted as 302 contains all of those elements that use the first four parameters (all elements in this example). These four parameters form a set of configuration parameters that are common to the class of network elements. The sub-class or child class 304 contains all of the network elements that are in the class 302 and, in addition, use parameters 212 and 214 (PARAM 3 and PARAM 4, respectively). This is a sub-class (or child class) of the network elements in class 302. Similarly, the sub-class (child class) 306 contains all of the network elements that are in the parent class 302 and, in addition, use parameter 210 (PARAM 2) and the sub-class 308 contains all of the network elements that are in the parent class 302 and, in addition, use parameters 210, 212 and 214 (PARAM 2, PARAM 3 and PARAM 4, respectively). Classes 304, 306 and 308 are all sub-classes, or child classes, of the network elements in parent class 302.

In a similar fashion, sub-sub-classes 310 and 312 are sub-classes of the sub-class 306.

If a network element of the sub-sub-class 312 is to be configured by a network operator, it is known that it requires PARAM 6. Also, since it is a sub-class of class 306, it also requires PARAM 2. Also, since class 306 is a sub-class of class 302, the element also requires SITE ID, ALIAS, GROUP and PARAM 1. In this manner, the network element in class 312 is said to inherit parameters from classes 306 and 302.

By selecting the class of the element (312 in this example), the list of parameters may be generated by inheritance from higher level classes. The element can then be configured by assigning values to these parameters and storing them on the server of master site.

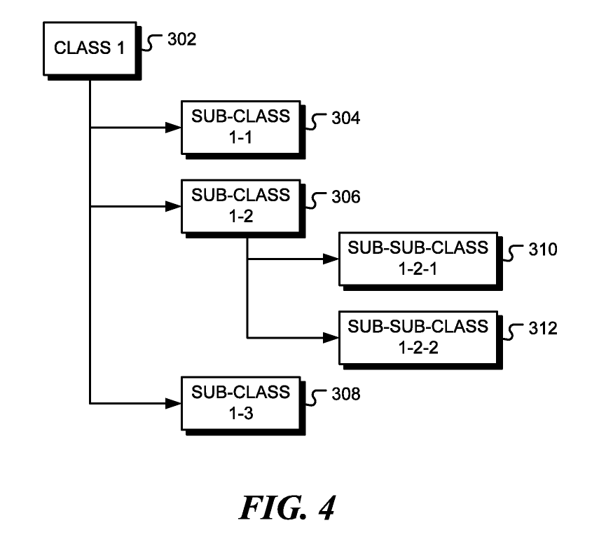

FIG. 4 is a diagram of an exemplary hierarchical class structure for the network elements represented in FIG. 3. The class structure is based upon common configuration parameters. Thus, all of the parameters of class 1 (302) are common to the other classes. Similarly, all of the parameters of sub-class 1-2 (306) are common to sub-sub classes 1-2-1 (310) and 1-2-2 (312).

In accordance with certain embodiments of the invention, the use of a hierarchical class structure, with parameter inheritance, for network elements based upon configuration parameters enhances the navigation and management of configuration parameters in a UCM application.

One enhancement is the use of a hierarchical structure for report generation. For example given in FIG. 2, a list of all of the parameters common to class 1 (302) elements can easily be generated.

The hierarchical structure facilitates generation of new element classes that are sub-classes of existing elements. In addition, the structure makes clear the relationship between different classes of network elements.

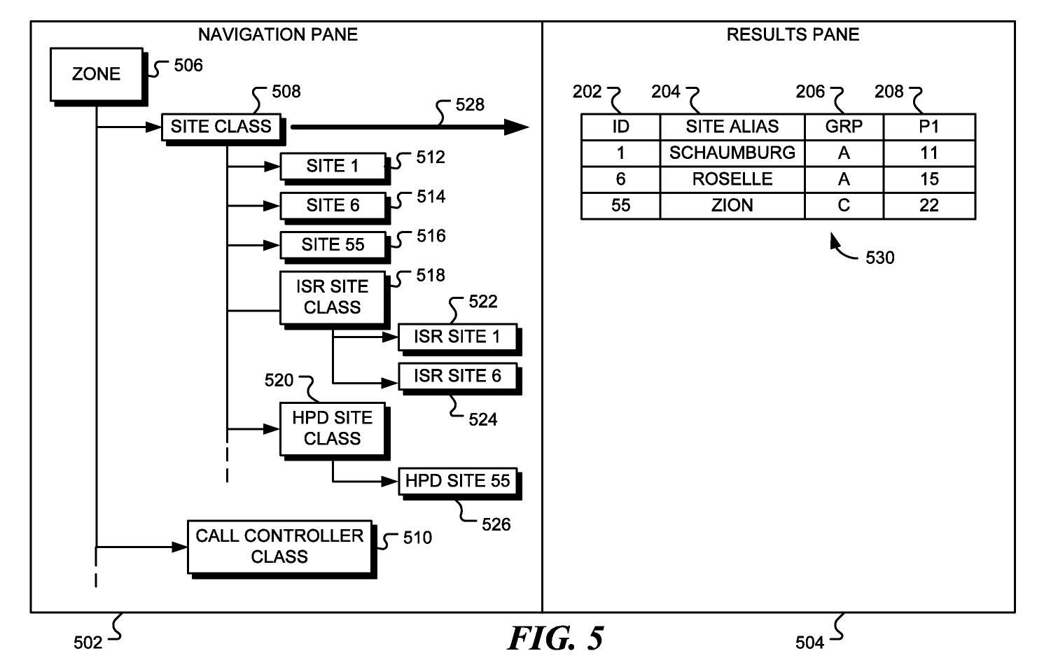

FIG. 5 is a diagrammatic representation of a computer display generated by a UMC application, consistent with certain embodiments of the invention. The display includes a navigation pane 502 and a results pane 504. The navigation pane 502 is operable to show elements of a trunked radio system in a hierarchical structure that is dependent upon the configuration parameters. In the exemplary navigation pane 502, a zone 506 includes two classes of elements: a site class 508 and call controller class 510. In this example, there are three sites (512, 514 and 516) in the site class. In addition, there are two sub-classes of the site class 508: an integrated server receiver (ISR) site class 518 and a high performance data (HPD) site class 520. Two of the three sites (522 and 524) are members of the ISR site class, while the third site 526 is a member of the HPD site class. A network element that contains a unique parameter will be in a class on its own, but may still be a sub-class of other network elements classes.

In this example, the navigation pane 502 displays both classes (508, 518, 520, for example) and instances of classes (512, 522 and 526, for example).

A user of the UMC application may chose to show or hide different levels of the hierarchical structure using techniques well known to those of ordinary skill in the art. In addition, a user may select an element of the display. When an element is selected, corresponding configuration parameters are displayed in the results pane. In the example shown in FIG. 5, the site class 508 is selected, as indicated by the arrow 528. Table 530 is displayed in the results pane as a result of the selection. In this example, members of the site class 508 have four configuration parameters in common: a site identifier, a site alias, a security group, and a first parameter (202, 204, 206 and 208 respectively). The results table 530 shows the values of these common configuration parameters for all members of the class. This approach allows a user or operator to easily view, for example, all site identifiers currently in use in the zone.

If the instance 512 were selected instead, only the first row of the table 530 would be displayed in the results pane. This would display only those parameters of SITE 1 that are common parameters of the site class.

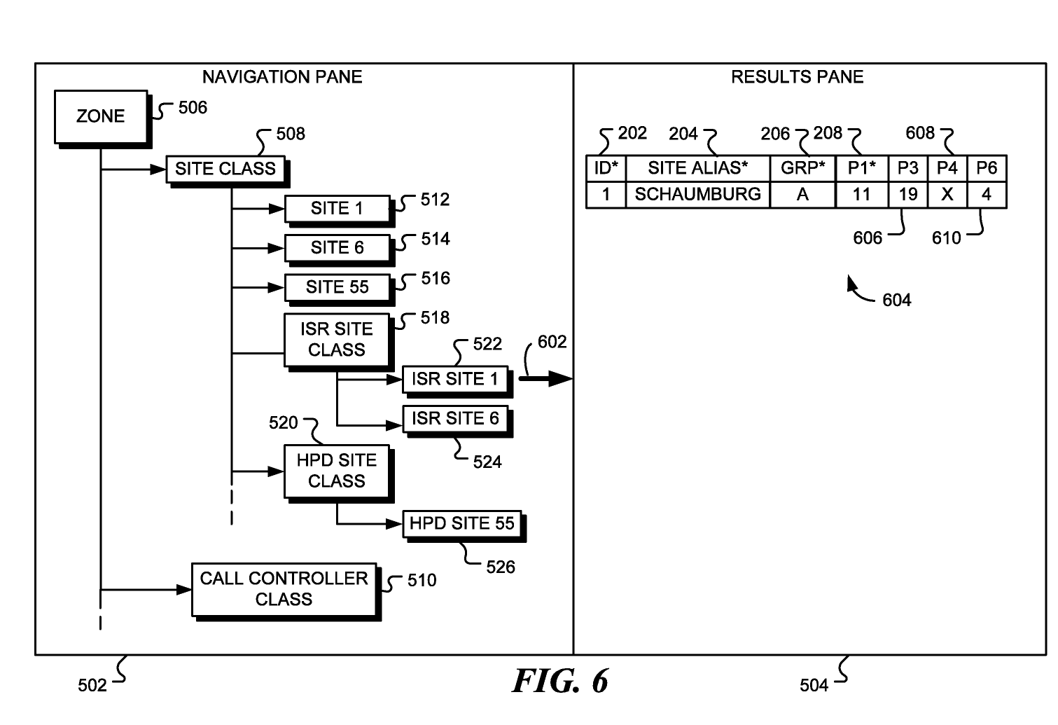

FIG. 6 is a further diagrammatic representation of a computer display generated by a UMC application. In FIG. 6, ISR site 1 (522) has been selected by the user, as indicated by the arrow 602. The selection causes the result table 604 to be displayed in the results pane 504. The results table 604 shows the parameters for all of the sites of this class, which, in this case, is a single site. The configuration parameters displayed include the parameters 202, 204, 206 and 208 inherited from the base site class 508. Parameters 606, 608 and 610 are inherited from the site class 518 and the parameter 612 is unique.

The inherited parameters may be identified in the display. In this example an asterisk is used to indicate inherited parameters, but color coding, highlighting or other indicator techniques may be used. Equivalently, the configuration parameters that are unique to the class (i.e., not inherited) may be indicated.

In a trunked radio network, example classes are sites and individual users. Example sub-classes with the site class include trunked RF sites, HPD sites, conventional sites and console sites. Example sub-classes within the individual user class include radio users and console users.

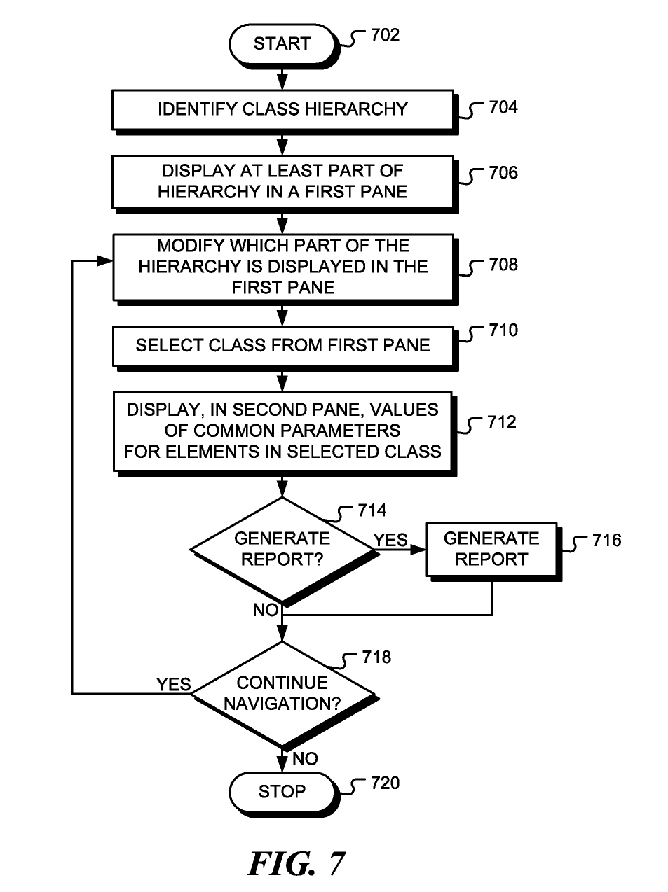

FIG. 7 is a flow chart of a method for navigating and displaying configuration parameters of network elements of a radio network consistent with certain embodiments. Following start block 702 in FIG. 7, a hierarchy of network element classes is identified at block 704, in which elements of a network element class share common configuration parameters and a sub-class of a network element class inherits configuration parameters from that network element class. At block 706 at least part of the hierarchy of network element classes is displayed on a first pane of a computer display. At block 708, the user elects to modify which part of the hierarchy is displayed by collapsing or expanding branches of the hierarchy in the display. At block 710, the user selects a network element class to be displayed from the network element classes displayed on the first pane of the computer display. At block 712, the values of configuration parameters common to the selected network element class are displayed on a second pane of the computer display for each network element in the selected network element class. In this way, the user is able to view common configuration parameters easily.

At decision block 714 in FIG. 7, the user selects if a report is to be generated corresponding to the current display. If a report of the configuration parameter values is to be generated, as depicted by the positive branch from decision block 714, a report is generated at block 716. If no report is to generated, as depicted by the negative branch from decision block 714, flow continues to decision block 718, where the user may elect to end the process, as depicted by the negative branch from decision block 718 and the termination block 720. If the user decides to continue navigation, as depicted by the positive branch from decision block 718, flow returns to block 708.

When configuring a new network element, a user may (a) select an existing class that includes all of the required configuration parameters for the element and generate a new member of that class; (b) select a class that contains some of the required configuration parameters for the element and generate a new sub-class to include the remainder of the configuration parameters; or (c) generate a new class of element. Using approach (a) or (b) simplifies the configuration of network elements and ensures compatibility between elements of the same class.

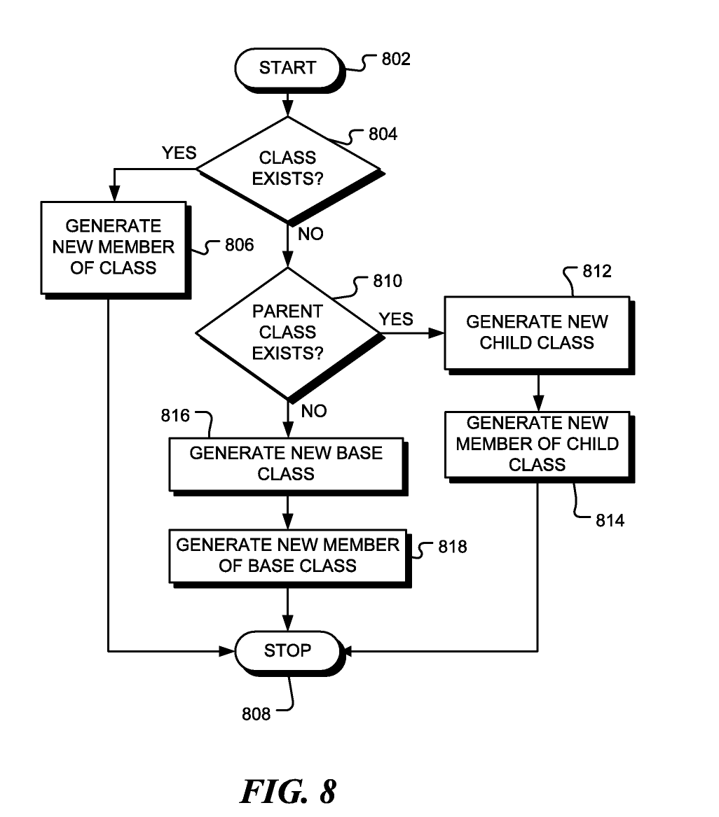

FIG. 8 is a flow chart of a method for configuring a new network element. Following start block 802 in FIG. 8, a check is made at decision block 804 to determine if the new element has configuration parameters corresponding to those of an existing class. This check may be performed by an operator or by the UCM application once the list of configuration parameters has been identified. If the parameters correspond to an existing class, as depicted by the positive branch from decision block 804, a new member of the existing class is generated at block 806 and the operator can set values for configuration parameters. The process terminates at block 808. If the parameters of the new element do not correspond to an existing class, as depicted by the negative branch from decision block 804, flow continues to decision block 810. At decision block 810 a check is made to determine if the new element has some configuration parameters that correspond to those of an existing class. Again, this check may be performed by an operator or by the UCM application, once the list of configuration parameters has been indicated. If some of the parameters correspond to an existing class, as depicted by the positive branch from decision block 810, that class is used as a parent class and a new child class is generated at block 812. The child class inherits the parameters of the parent class and adds the parameters that are unique to the child class. At block 814, a new member of the child class is generated and the operator can set values for configuration parameters. The process terminates at block 808. If none of the parameters of the new element are common to an existing class, as depicted by the negative branch from decision block 810, a new base class is generated at block 816 and the new network element is added as a member of the new class at block 818. The process terminates at block 808.

When a new class (or sub-class) member is generated, a user interface of configuration parameters common to the class may be presented to the user. This allows the user to specify values for the configuration parameters. Business rules may be applied to ensure that the parameter values are acceptable.

When a new parameter is to be added to a class of network elements, the new parameter may be added to the root class. This ensures that all of the sub-class or child class network elements inherit the new parameter and consistency is maintained.

The hierarchical structure of configuration parameters may be used to control access to parameters. A user may be permitted to change parameter values at one level of the hierarchy, but not at higher levels. For example a user may be prevented from modifying the site identifier, site alias and other base parameters of a site, but may be permitted to change other parameters that are unique to a particular class of sites.

The present invention, as described in embodiments herein, is implemented using a programmed processor executing programming instructions that are broadly described above in flow chart form that can be stored on any suitable computer readable storage medium. However, those skilled in the art will appreciate that the processes described above can be implemented in any number of variations and in many suitable programming languages without departing from the present invention. For example, the order of certain operations carried out can often be varied, additional operations can be added or operations can be deleted without departing from the invention. Error trapping can be added and/or enhanced and variations can be made in the user interface and information presentation without departing from the present invention. Such variations are contemplated and considered equivalent.

Those skilled in the art will appreciate that the program steps and associated data used to implement the embodiments described above can be implemented using disc storage as well as other forms of storage, such as, for example, read only memory (ROM) devices, random access memory (RAM) devices, optical storage elements, magnetic storage elements, magneto-optical storage elements, flash memory and/or other equivalent storage technologies without departing from the present invention. Such alternative storage devices should be considered equivalents.

While the invention has been described with reference to a trunked radio network, it will be apparent to those of ordinary skill in the art that the foregoing methods may be applied to other systems in which system elements use configuration parameters. Examples include wired and wireless computer networks and cellular telephone/data networks.

While the invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications and variations as fall within the scope of the appended claims.

What is claimed is:

1. A method for displaying configuration parameters of network elements of a: network, the method comprising:
identifying a hierarchy of network element classes, wherein members of a network element class share common configuration parameters and wherein a sub-class of a network element class inherits configuration parameters from that network element class;
displaying at least part of the hierarchy of network element classes on a first pane of a computer display;
selecting a network element class from the network element classes displayed on the first pane of the computer display; and
displaying the values of configuration parameters common to the selected network element class on a second pane of the computer display for each network element in the selected network element class.

2. A method in accordance with claim 1, further comprising indicating in the second pane which configuration parameters are inherited from a parent class.

3. A method in accordance with claim 1, wherein the network comprises a trunked radio network.

4. A method in accordance with claim 3, wherein hierarchy of network element classes comprises a site class and an individual user class.

5. A method in accordance with claim 4, wherein the site class has at least one child class selected from the group consisting of a trunked RF site class, a high performance data (HPD) site class, a conventional site class and a console site class.

6. A method in accordance with claim 4, wherein the individual user class has at least one child class selected from the group consisting of a radio user site class and a console user class.

7. A method in accordance with claim 1, further comprising:
generating a report containing the values of the configuration parameters common to the selected network element class for each network element in the selected network element class; and
outputting the report.

8. A computer readable medium containing programming instructions that, when executed on a computer, perform the method of claim 1.

9. A method for configuring a network element of a network having a plurality of configuration parameters, the method comprising:
segmenting the plurality of configuration parameters into at least one first set of configuration parameters, each first set of configuration parameters common to a class of network elements, and at least one second set of configuration parameters, each second set of parameters common to a sub-class of a class of network elements; and
generating a new member of an existing sub-class of network elements if all of the configuration parameters of the network element are common with the second set of parameters of the existing sub-class of network elements.

10. A method in accordance with claim 9, further comprising:
if a set of configuration parameters of the network elements are common with the first set of configuration parameters of an existing class of network element, and the network element has at least one unique configuration parameters:
generating a new sub-class of the existing class of network elements, the new sub-class inheriting the configuration parameters of the existing class of network elements;
adding the at least one unique configuration parameter to the new sub-class; and
generating a member of the new sub-class; and
if no set of configuration parameters of the network element is common with the configuration parameters of an existing class of network elements:
generating a new class of network elements; and
generating a member of the new class of network elements.

11. A method in accordance with claim 9, wherein generating a member of a new class or sub-class comprises:
assigning values to the configuration parameters corresponding to the class or sub-class class; and
storing the values of the configuration parameters.

12. A method in accordance with claim 9, wherein the network comprises a trunked radio network.

13. A method in accordance with claim 11, wherein the network comprises a trunked radio network, and wherein storing the values of the configuration parameters comprises storing the values on a server of a master site of the trunked radio network.

14. A computer readable medium containing programming instructions that, when executed on a computer, perform the method of claim 9.

15. A method in accordance with claim 9, further comprising:
comparing the plurality of configuration parameters of the network element to configuration parameters of existing classes of network parameters;
identifying the network element as a member of an existing class of the at least some of the plurality of configuration parameters are common with the set of configuration parameters of the existing class.

16. A method in accordance with claim 9, wherein the method is implemented by a software tool, the method further comprising:
controlling the generation of a new class of network elements dependent upon an authorization level of a user.

17. A method in accordance with claim 9, wherein the method is implemented by a software tool, the method further comprising:
controlling the generation of a new sub-class of network elements dependent upon an authorization level of a user.

18. A method for network configuration management in a network comprising a plurality of network elements, each network element having configuration parameters associated with it, the method comprising:
displaying at least part of a hierarchy of network element classes on a first pane of a computer display, wherein members of a network element class in the hierarchy of network element classes share common configuration parameters and wherein a sub-class of a network element class inherits configuration parameters from that network element class;
selecting a network element class from the hierarchy of network element classes in response to a user input; and
displaying configuration parameters common to the selected network element class on a second pane of the computer display for each network element in the selected network element class.

19. A method in accordance with claim 18, further comprising:
displaying at least one class member of the hierarchy of network element classes on the first pane of a computer display;
selecting a class member from the at the least one class members in response to a user input; and
displaying a user interface of configuration parameters of the selected class member that are common to the network element class of the selected class member on the second pane of the computer display,
receiving configuration parameters from the user interface; and
storing the configuration parameters received from the user interface.

20. A method in accordance with claim 18, wherein the network comprises a trunked radio network.
